(19) United States
(12) Patent Application Publication
(10) Pub. No.: US 2008/0150430 A1
(43) Pub. Date: Jun. 26, 2008

(54) Protective tube for a fluorescent lamp and method

(76) Inventor: Roger B. Enterkin, West Monroe, LA (US)

Correspondence Address: John M. Harrison, 2139 E. Bert Kouns, Shreveport, LA, 71105, US

(21) Appl. No.: 11/643,966

(22) Filed: Dec. 22, 2006

(51) Int. Cl. H01J 61/36; H01J 9/02

(52) U.S. Cl. 313/624; 445/23

(57) ABSTRACT

A protective tube which is thermally shrink-fitted over at least the end portions of a fluorescent lamp, with the protective tube encapsulating the fluorescent lamp tube and overlapping a portion of the ends of the terminal caps terminating each end of the lamp tube. The protective tube forms a seal between the protective tube, the lamp tube and the terminal caps. A fluorescent lamp having a protective tube thereon, which protective tube seals the glass tube and terminal caps of the fluorescent tube and partially overlaps the ends of the terminal caps from which the terminals project. A method of encapsulating a fluorescent lamp tube in a protective tube, which includes the steps of placing a protective tube over the fluorescent lamp tube and terminal caps such that the ends of the protective tube extend beyond the ends of the terminal caps; placing a forming sleeve over each end of the protective tube and lamp tube; heating the forming sleeves and at least the end portions of the protective tube to thermally fit the forming sleeves on the protective tube and the protective tube on the lamp tube and the terminal caps, with the ends of the protective tube overlapping a portion of the ends of the terminal caps from which the terminals project; and removing the forming sleeves from the protective tube.

### SUMMARY OF THE INVENTION

A protective tube for encapsulating the glass tube of a fluorescent lamp and extending over and overlapping a portion of the ends of the terminal caps from which the terminals project, which terminal caps terminate the ends of the glass tube. A fluorescent lamp having a protective tube thereon, which protective tube seals the glass tube and terminal caps of the fluorescent tube and overlaps a portion of the ends of the terminal caps from which the terminals project. A method of protecting a fluorescent lamp which includes the steps of slipping a protective tube over the glass tube and terminal caps of the fluorescent lamp, such that the ends of the protective tube extend beyond the ends of the terminal caps; slipping a forming sleeve on each end of the protective tube; heating the forming sleeves and at least the end portions of the protective tube to shrink-fit the forming sleeves on the protective tube and at least the end portions of the protective tube on the glass tube and terminal caps, such that the ends of the protective tube overlap a portion of the ends of the terminal caps from which the terminals project; and removing the forming sleeves from the ends of the fluorescent tube.

### BRIEF DESCRIPTION OF THE DRAWINGS

The invention will be better understood by reference to the accompanying drawings, wherein:

FIG. 1 is a perspective view of a fluorescent lamp having a thermally-fitted protective tube thereon and provided with a pair of terminals projecting from terminal caps at the ends thereof;

FIG. 2 is a sectional view taken along line 2-2 of the fluorescent lamp and protective tube illustrated in FIG. 1;

FIG. 3 is an exploded view of the fluorescent lamp and protective tube illustrated in FIGS. 1 and 2, more particularly illustrating a forming sleeve for fitting over the ends of the fluorescent lamp and protective tube;

FIG. 4 is a perspective view of one end of a fluorescent lamp with a protective tube and forming sleeve in place before application of heat;

FIG. 5 is a sectional view taken along line 5-5 in FIG. 4 of the fluorescent lamp and the protective tube and forming sleeve in place and also illustrating typical heating elements for applying heat to the forming sleeve and protective tube;

FIG. 6 is a perspective view of the end of the fluorescent lamp illustrated in FIGS. 4 and 5, with the protective tube and forming sleeve thermally deformed and tightened on the fluorescent lamp;

FIG. 7 is a sectional view taken along line 7-7 of the essentially encapsulated end of the fluorescent lamp illustrated in FIG. 6; and

FIG. 8 is a perspective view of the end of the fluorescent lamp fitted with the thermally tightened protective tube illustrated in FIGS. 6 and 7, wherein the thermally deformed forming sleeve is removed.

### DESCRIPTION OF THE PREFERRED EMBODIMENTS

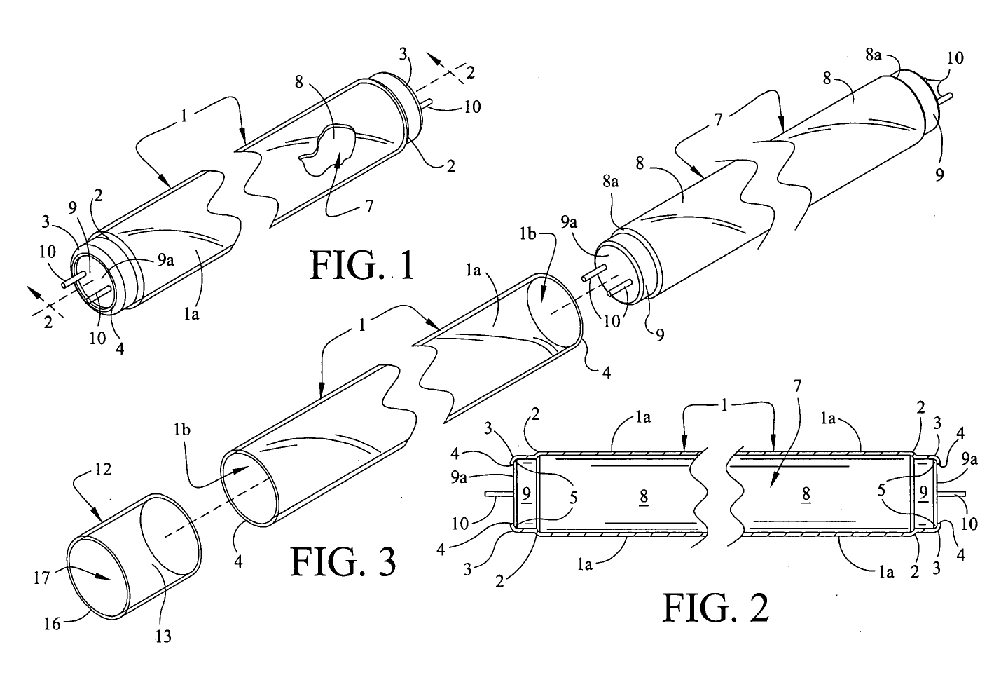

In one embodiment of the invention a fluorescent lamp is illustrated by reference numeral 7 in FIGS. 1-3 and receives a protective tube 1 in a slip-fit, with the tube ends 4 of the protective tube 1 extending beyond the respective terminal caps 9 that close opposite ends of the glass lamp tube 8 of the fluorescent tube 7, at opposite lamp tube shoulders 8a (FIG. 3). A pair of terminals 10 typically extend from each of the terminal caps 9 in a bi-pin lamp configuration, for engaging the electrical receptacles in a lamp fixture (not illustrated) in conventional manner. It will be recognized that the lamp tube 8 may be fitted with other pin configurations, such as the single-pin or recessed, double-contact design (not illustrated), in non-exclusive particular, as desired.

The tube wall 1a (FIG. 2) of the protective tube 1 which defines a tube bore 1b (FIG. 3) typically has a wall thickness of from about 0.013 inch to about 0.026 inch and generally about 0.015 inch by way of example, and may typically be constructed of a clear or translucent polymeric material such as polycarbonate tubing. The protective tube 1 may be tinted or colored or otherwise treated to provide a desired light emission, as desired. The inside diameter or tube bore 1b of the protective tube 1 is slightly larger, typically about 1/16 inch, than the outside diameter of the lamp tube 8 of the fluorescent lamp 7 to facilitate easy sliding or slipping of the protective tube 1 over the fluorescent lamp 7.

Since a primary purpose of the protective tube 1 is to encase or seal the glass lamp tube 8 and prevent glass particles and phosphor powders from spreading and scattering if the glass lamp tube 8 is broken, the protective tube 1 is thermally tightly or snugly seated at least on the two terminal caps 9 in an overlap configuration. This objective is realized by using a pair of forming sleeves 12, one of which is illustrated in FIGS. 3, 4 and 5, the sleeve bores 17 of which are sized to fit easily over the ends of the protective tube 1 and the underlying fluorescent lamp 7, as illustrated. The forming sleeves 12 are typically constructed of a polymeric material such as polycarbonate and may be about four or five inches long, but may also be substantially any length that covers the terminal caps 9 and lamp tube shoulders 8a underlying the respective ends of the protective tube 1. The forming sleeves 12 also typically have a sleeve wall 13 thickness in the range of from about 0.13 inch to about 0.026 inch.

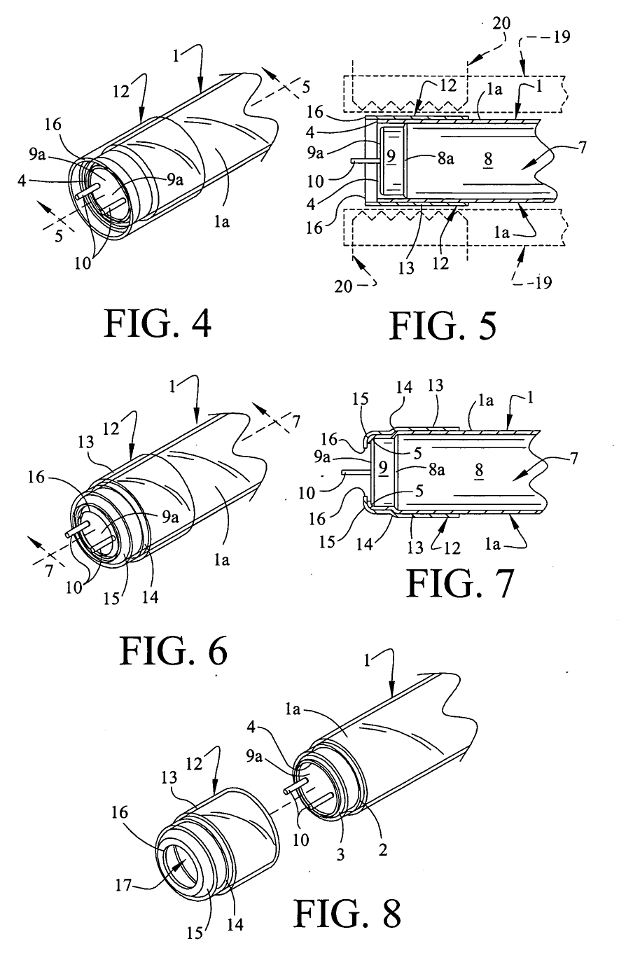

Referring again to FIGS. 4 and 5 of the drawings, after the protective tube 1 is positioned on the lamp tube 8 and terminal caps 9 of the fluorescent tube 7 and the forming sleeves 12 are fitted over the ends of the protective tube 1 as described above, these elements are heated, typically using electric heaters 19, each having heating elements 20, illustrated in phantom in FIG. 5. It will be appreciated that at least the end portions of the fluorescent lamp 7 and the protective tube 1, as well as the forming sleeve 12 assembly elements may typically be placed in or passed through a heated environment, with one or more of the heaters 19 fixed in place or one or more of the heaters 19 may be moved around the loosely encapsulated fluorescent tube 7 or around the end portions thereof, to apply a selected amount of heat to the protective tube 1 and the forming sleeves 12. Heat may typically be applied as detailed in U.S. Pat. No. 5,729,085, which issued on Mar. 17, 1998.

As illustrated in FIGS. 6 and 7, application of heat to the protective tube 1 and forming sleeve 12 components, typically using the heaters 19 in a desired configuration and application, causes at least the end portions of the protective tube 1 and the forming sleeves 12 to thermally deform or shrink on the protective tube 1 and encapsulate the lamp tube 8 and terminal caps 9 of the fluorescent lamp 7. Alternatively, a hot air gun or the like can be used to achieve the desired thermal deformation. The heat-induced thermal deformation action of the forming sleeves 12 causes the already shrinking and tightening underlying end segments or portions of the protective tube 1 to tighten even more on the lamp tube 8 at and near the lamp tube shoulder 8a and on the terminal caps 9 with a greater tension than may be realized with only the shrinkage and tightening of the underlying end portions of the protective tube 1 on the fluorescent lamp 7 end components.

Referring now to FIGS. 1, 2 and 8 of the drawings, when the heat-induced shrinkage or thermal deformation process is complete, heat is removed from the fluorescent lamp 7 or these elements are removed from the heat produced in the heaters 19 (FIG. 5) or the like, and the forming sleeves 12 are removed from the ends of the protective tube 1, typically after the fluorescent lamp 7 has cooled (FIG. 8). This removal of the thermally deformed forming sleeves 12 from the ends of the fluorescent lamp 7 is easily accomplished, since the sleeve bend 15 and the sleeve end 16 elements of each forming sleeve 12 allow gripping of the forming sleeves 12. The heat-induced tension in the forming sleeves 12 at the respective sleeve shoulders 14 and sleeve bend 15, as well as along the entire length of the forming sleeves 12, accentuates a corresponding augmented shaping of the end segments and tube ends 4 of the protective tube 1 on the underlying lamp tube 8. This compounded heat-induced tension in both the forming sleeves 12 and the end segments of the protective tube 1 covered by the forming sleeves 12 effects a tight fit of the protective tube 1 on the lamp tube 8, particularly at the tube neck 2 and lamp tube shoulder 8a interface and along the terminal caps 9. The forming sleeve 12 and protective tube 1 shrinkage at the sleeve bend 15 and the tube bend 3 interface further effects a desired overlapping of the tube ends 4 against the corresponding cap end 9a of each of the terminal caps 9, to define a cap end overlap 5 (FIGS. 2 and 7) at each end of the protective tube 1. This cap end overlap 5 is typically in the range of from about 1/32 to about ⅛ of an inch, by way of example. The cap end overlap 5 is shaped by the added tension in the shrinking forming sleeves 12 and operates to further secure the protective tube 1 tightly and snugly on the fluorescent lamp 7.

It will be appreciated by those skilled in the art that the protective tube 1 may be constructed of polymeric materials such as polycarbonate, which is capable of thermal deformation to encapsulate a fluorescent lamp tube and has enough structural integrity to withstand an impact sufficient to break the underlying glass tube. The material must be sufficiently strong to contain the glass fragments, phosphor powder and other components of the fluorescent lamp tube. Furthermore, the forming sleeves 12 may be constructed of a like material, as desired.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. a protective tube assembly for protecting a fluorescent lamp having an elongated glass: tube and terminal caps at the ends of the glass tube, said protective tube assembly comprising a pre-formed polymeric material which fits over the glass tube and extends beyond the terminal caps and pre-formed polymeric sleeves which fit over the ends of the protective tube, wherein the ends of said protective tube substantially conform to the shape of the elongated glass tube and the terminal caps, said ends forming an overlap on the terminal caps to provide a seal on the terminal caps and the sleeves substantially conform to the ends of the protective tube, responsive to application of heat to said sleeves and at least the end portions of said protective tube.

2. The protective tube assembly of claim 1 wherein the polymeric material is a polycarbonate.

3. The protective tube of claim 1 wherein the protective tube has a wall thickness of from about 0.013 to about 0.026 inch.

4. The protective tube assembly of claim 1 wherein:
(a) the polymeric material and the sleeves are a polycarbonate; and
(b) the protective tube of claim 1 wherein the protective tube and the sleeves have a wall thickness of from about 0.013 to about 0.026 inch.

5. The protective tube assembly of claim 1 wherein said overlap on the terminal caps has a width of from about 1/32 to about ⅛ of an inch.

6. The protective tube assembly of claim 5 wherein the polymeric material is a polycarbonate.

7. The protective tube assembly of claim 5 wherein the protective tube has a wall thickness of from about 0.013 to about 0.026 inch.

8. The protective tube assembly of claim 5 wherein:
(a) the polymeric material and the sleeves are a polycarbonate; and
(b) the protective tube assembly of claim 1 wherein the protective tube and the sleeves have a wall thickness of about 0.015 inch.

9. A fluorescent lamp having a polymeric protective tube thereon, the fluorescent lamp characterized by an elongated glass tube and a metal terminal cap at each end of the glass tube and the protective tube extending over the glass tube and sealing the glass tube and the terminal caps, wherein the protective tube overlaps a portion of the ends of the terminal caps when said protective tube is thermally deformed on the glass tube and terminal caps.

10. The fluorescent lamp of claim 9 wherein the polymeric protective tube is a polycarbonate.

11. The fluorescent lamp of claim 9 wherein the protective tube has a wall thickness of from about 0.013 to about 0.026 of an inch.

12. The fluorescent lamp of claim 9 wherein:
(a) the polymeric material is a polycarbonate; and
(b) the protective tube of claim 1 wherein the protective tube has a wall thickness of from about 0.013 to about 0.026 of an inch.

13. The fluorescent lamp of claim 9 wherein the ends of the protective tube overlap the ends of the terminal caps by about 1/32 to about ⅛ of an inch.

14. The fluorescent lamp of claim 9 wherein the protective tube has a wall thickness of from about 0.013 to about 0.026 of an inch and the ends of the protective tube overlap the ends of the terminal caps by about 1/32 to about ⅛ of an inch.

15. The fluorescent lamp of claim 14 wherein the polymeric protective tube is a polycarbonate.

16. A method for sealing a fluorescent lamp having terminal caps at each end in a protective tube, comprising the steps of placing the protective tube over the fluorescent lamp, wherein the ends of the protective tube extend beyond the terminal caps; inserting forming sleeves over the ends of the protective tube; heating the forming sleeves and at least the ends of the protective tube and thermally shrinking the forming sleeves on the ends of the protective tube and at least the ends of the protective tube on the fluorescent lamp, with the ends of the protective tube overlapping a portion of the ends of the terminal caps; and removing the forming sleeves from the ends of the protective tube and the fluorescent lamp.
